(19) United States
(12) Patent Application Publication
(10) Pub. No.: US 2012/0152578 A1
(43) Pub. Date: Jun. 21, 2012

(54) Screw Driver

(75) Inventors: Norikazu Baba, Ibaraki (JP); Yoshiichi Komazaki, Ibaraki (JP)

(73) Assignee: Hitachi Koki Co., Ltd., Tokyo (JP)

(21) Appl. No.: 13/324,743

(22) Filed: Dec. 13, 2011

(30) Foreign Application Priority Data
Dec. 16, 2010 (JP) 2010-280625

(51) Int. Cl. B25B 21/00; B25B 23/00

(52) U.S. Cl. 173/15

(57) ABSTRACT

A screw driver capable of stably stopping a bit to stabilize fastening depth of a screw. The screw driver includes a rotary portion, a housing, and a clutch mechanism. The rotary portion is rotated by a power source and has a bit engageable with a screw. The rotary portion also has a moving portion holding the bit and movable between a top dead center and a bottom dead center in an axial direction of the rotary portion. The housing rotatably supports the rotary portion. The clutch mechanism includes a first clutch plate unrotatable relative to the housing, and a second clutch plate movable in the axial direction and rotatable integrally with the rotation of the rotary portion. The first and second clutch plates are positioned to be urged by the moving portion and pressed together when the moving portion reaches the bottom dead center.

### CROSS REFERENCE TO RELATED APPLICATION

This application claims priority from Japanese Patent Application No. 2010-280625 filed Dec. 16, 2010. The entire content of each of these priority applications is incorporated herein by reference.

### TECHNICAL FIELD

The present invention relates to a screw driver, and more particularly, to such screw driver capable of avoiding excessive fastening or driving of the screw.

### BACKGROUND

Japanese Patent Application Publication No. 2008-168361 discloses a screw driver having a compressed air source as a power source for rotating and impacting a bit. More specifically, a pneumatic motor is rotationally driven by a compressed air for rotating the bit and for driving a piston so as to impart impacting force on the bit. In the above-described conventional screw driver, a supply of compressed air to the pneumatic motor is shut off concurrently with the movement of the bit toward its bottom dead center in order to restrict rotation of the bit.

### SUMMARY

The present inventors have found that driving depth of the screw (driving stroke of the bit) may be varied because the pneumatic motor cannot be promptly stopped due to inertial force. In view of the foregoing, it is an object of the present disclosure to provide a screw driver capable of stopping the bit with a certainty irrespective of the inertial force of the pneumatic motor, to thereby stabilizing driving depth of the screw.

In order to attain the above and other objects, the present invention provides a screw driver including a power source, a rotary portion, a housing, and a clutch mechanism. The rotary portion is rotated by the power source and has a bit engageable with a screw. The rotary portion also has a moving portion holding the bit and movable between a top dead center and a bottom dead center in an axial direction of the rotary portion. The housing rotatably supports the rotary portion. The clutch mechanism is provided between the rotary portion and the housing and is coaxially with the rotary portion. The clutch mechanism includes a first clutch plate associated with the housing and unrotatable relative to the housing, and a second clutch plate associated with the rotary portion and movable in the axial direction and rotatable integrally with the rotation of the rotary portion. The first and second clutch plates are positioned to be urged by the moving portion and pressed together when the moving portion reaches the bottom dead center.

### BRIEF DESCRIPTION OF THE DRAWINGS

The particular features and advantages of the invention as well as other objects will become apparent from the following description taken in connection with the accompanying drawings, in which:

FIG. 1 is a cross-sectional view of a screw driver according to one embodiment of the present invention;

FIG. 2 is a cross-sectional view of the screw driver particularly showing a main body portion thereof according to the embodiment;

FIG. 3 is a cross-sectional view of the screw driver particularly showing a clutch mechanism thereof according to the embodiment;

FIG. 4 is a cross-sectional view taken along the line IV-IV in FIG. 3;

FIG. 5 is a cross-sectional view taken along the line V-V in FIG. 3

FIG. 6 is a cross-sectional view of the screw driver particularly showing a cylinder and ambient components after impacting operation; and

FIG. 7 is a cross-sectional view of a screw driver particularly showing a cylinder and ambient components according to a modified embodiment of the present invention.

### DETAILED DESCRIPTION

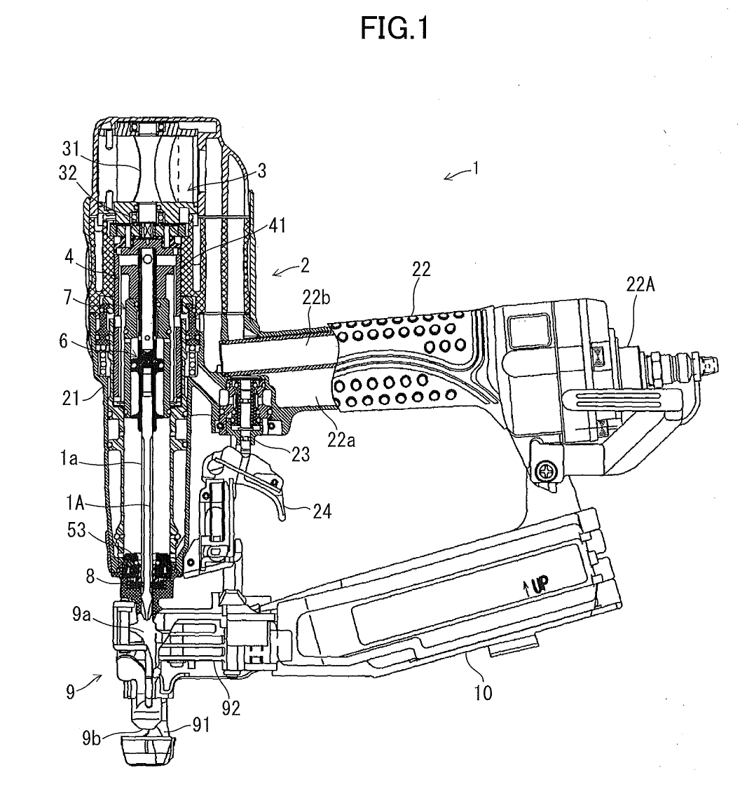

A screw driver according to one embodiment of the present invention will be described with reference to FIGS. 1 through 6. A screw driver 1 has a bit section 1A adapted to fasten or drive a fastener such as a screw into a workpiece, and includes a main body 2, a nose portion 9, and a magazine 10. The main body 2 has a housing 21 as an outer shell having one end portion provided with the nose portion 9. A direction from the housing 21 to the nose portion 9 will be referred to as a downward direction.

The bit section 1A is of elongated cylindrical shape whose tip end portion is provided with a bit engageable with a screw. The bit section 1A has a main portion formed with a plurality of grooves 1a extending in a vertical direction as shown in FIGS. 1 and 5.

The housing 21 has a vertically intermediate portion provided with a handle 22 extending in a direction crossing the longitudinal direction of the housing 21. A compressed air accumulating chamber 22a is formed in the handle 22, and a compressed air inlet 22A is provided at a free end of the handle 22 opposite to the housing 21. Therefore, a compressed air can be introduced into the compressed air accumulating chamber 22a through the air inlet 22A. A discharge passage 22b isolated from the compressed air accumulating chamber 22a extends in the handle 22 and is open at a position adjacent to the air inlet 22A. The discharge passage 22b is in communication with a pneumatic motor 31 described later.

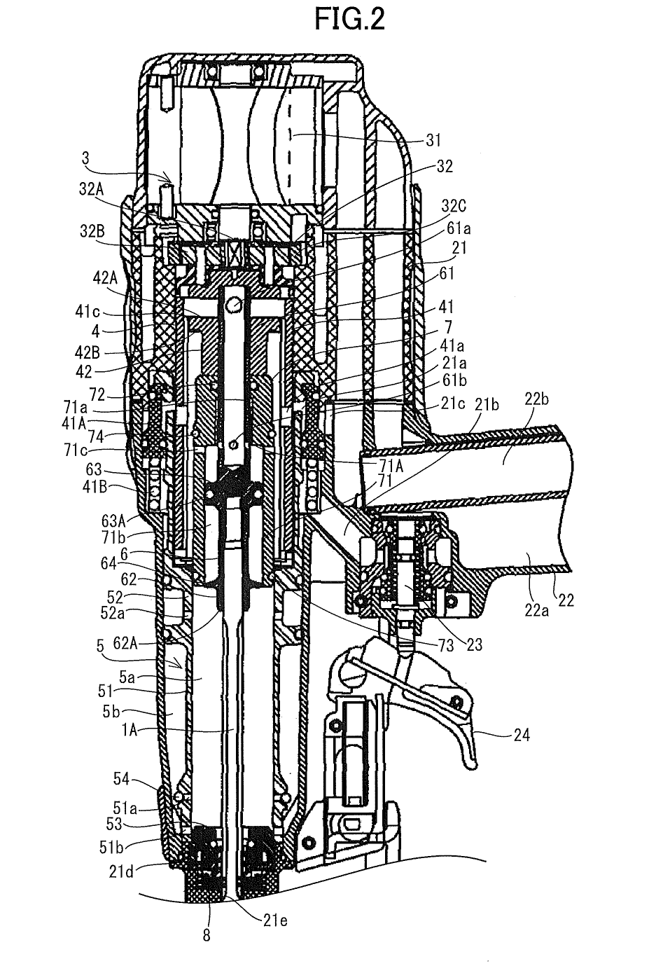

As shown in FIG. 2, an operation valve 23 and a trigger 24 are provided in the housing 21 at a position adjacent to a base end portion of the handle 22. Further, a first air passage 21b and a groove 21a are formed in the housing 21. The first air passage 21b is configured to communicate with the operation valve 23, and the groove 21a is configured to vertically movably accommodate a main valve 41A described later. The operation valve 23 is adapted to control communication between the first air passage 21b and an atmosphere. A communication between the first air passage 21b and the atmosphere is shut off in case of non-operation of the operation valve 23, and the communication is attained in case of the operation of the operation valve 23. The trigger 24 is configured to operate the operation valve 23 in co-operation with a push lever 91 described later. The groove 21a is positioned around a rotary sleeve 41 described later and at a vertically intermediate position thereof. The groove 21a has a lower end portion in communication with the first air passage 21b.

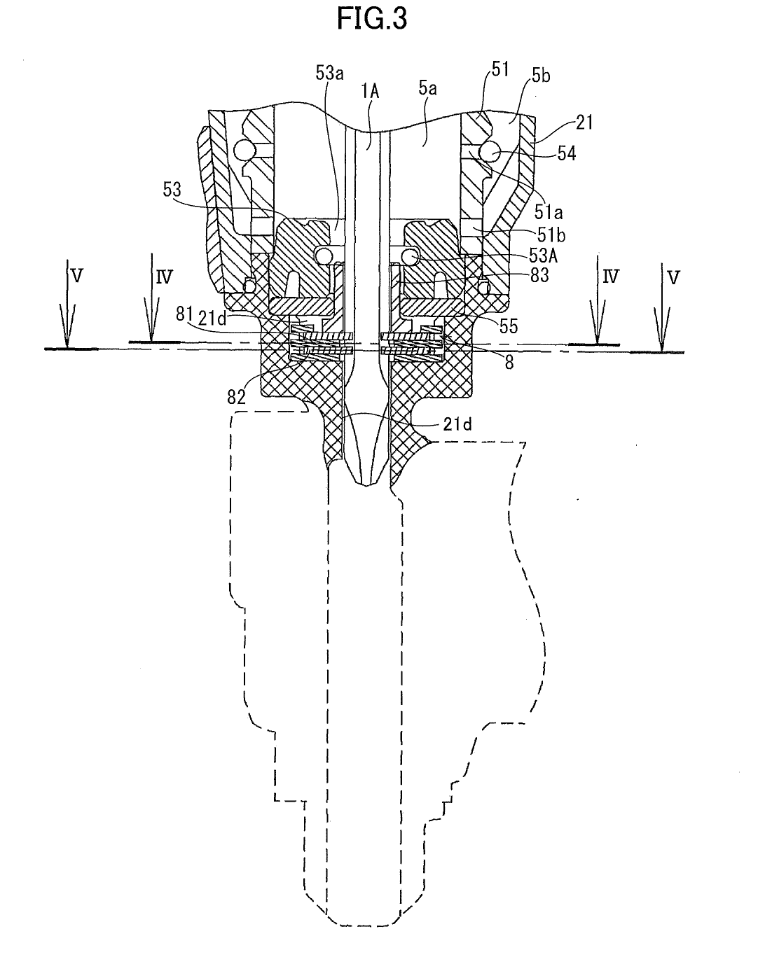

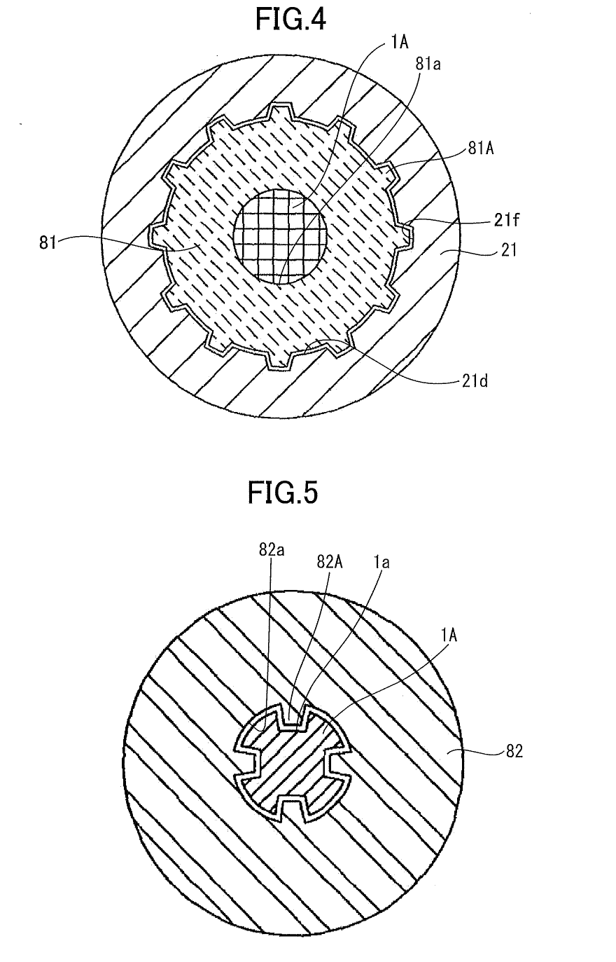

A second air passage 21c in communication with the compressed air accumulating chamber 22a is formed in the housing 21 at a position adjacent to the first air passage 21b and opened to the groove 21a. Further, a third air passage (not shown) is formed in the housing 21 for communicating a rotary assembly or a rotary portion 4 with the pneumatic motor 31. Further, as shown in FIG. 3, a clutch accommodation space 21d is provided at a lower end portion of the housing 21 for accommodating a clutch mechanism 8 described later. A through-hole 21e extending in a vertical direction is formed at a position below the clutch accommodation space 21d for permitting the bit section 1A to pass through the through-hole 21e. As shown in FIG. 4, a plurality of grooves 21f extending in the vertical direction are formed at a wall defining the clutch accommodation space 21d.

As shown in FIG. 2, a drive portion 3, the rotary assembly (rotary portion) 4 and a cylinder portion 5 are disposed in the housing 21. The drive portion 3 mainly includes the pneumatic motor 31 and a planetary gear mechanism 32, and is positioned at an upper end portion of the housing 21. The pneumatic motor 31 is positioned at an uppermost end portion within the housing 21, and has an output shaft extending in the vertical direction. The pneumatic motor 31 is rotatable in a well known manner by application of compressed air. The pneumatic motor 31 is in communication with the discharge passage 22b and is also communicated with the rotary assembly 4 through the third air passage (not shown). Since compressed air in the compressed air accumulating chamber 22a is supplied to the rotary assembly 4 through the third air passage, the supplied compressed air is supplied from the rotary assembly 4 to the pneumatic motor 31 through the third air passage and the compressed air is discharged from the pneumatic motor 31 to the atmosphere through the discharge passage 22b. Thus, the pneumatic motor 31 can be drivingly rotated by the compressed air.

The planetary gear mechanism 32 includes a sun gear 32A, a plurality of orbital gears 32B, and a ring gear 32C. The sun gear 32A is coaxial with the output shaft of the pneumatic motor 31 and rotatable together with the rotation of the output shaft. The orbital gears 32B are meshedly engaged with the sun gear 32A. The ring gear 32C is fixed to the housing 21 and meshedly engaged with the orbital gears 32B. The rotary sleeve 41 functions as a carrier, whose upper portion rotatably supports the orbital gears 32B. Thus, the planetary gear mechanism 32 is disposed below the pneumatic motor 31 and is coaxially connected with the output shaft (rotation shaft) of the pneumatic motor 31, and is rotationally driven by the pneumatic motor 31. The pneumatic motor 31 is connected to the rotary assembly 4, so that the rotation force of the pneumatic motor 31 is deceleratingly and coaxially transmitted to the rotary assembly 4. A combination of the drive portion 3 and the compressed air functions as a drive source for driving an auxiliary piston portion 6 (described later) and a main piston portion 7 (described later).

The rotary assembly 4 includes the rotary sleeve 41, a rotary slide member 42, the auxiliary piston portion 6, and the main piston portion 7. The rotary sleeve 41 is rotatably supported to the housing 21 and has a cylindrical shape having an upper closed end portion and lower open end portion. The plurality of orbital gears 32B are rotatably supported to the upper end portion of the rotary sleeve 41. With this structure, the rotary sleeve 41 functions as the carrier in the planetary gear mechanism 32 whereby rotation of the pneumatic motor 31 is deceleratingly transmitted to the rotary sleeve 41.

The rotary sleeve 41 has a peripheral wall whose axially intermediate portion is formed with a vent hole 41a open to the groove 21a. The main valve 41A is vertically movably positioned in the groove 21a and is biased upward by a spring 41B. The main valve 41A has a main valve vent hole (not shown) and has upper and lower peripheral end portions sealed against the housing 21. Thus, the sealing structure prevents the compressed air from leaking into the vent hole 41a through a gap between the main valve 41A and the housing 21.

The main valve vent hole (not shown) is positioned in the main valve 41A so that the main valve vent hole cannot be communicated with the vent hole 41a when the main valve 41A is positioned at the upper end side within the groove 21a, and can be communicated with the vent hole 41a when the main valve 41A is positioned at the lower end side within the groove 21a.

As described above, the groove 21a is communicated with the compressed air accumulating chamber 22a through the second air passage 21c, and is also communicated with the first air passage 21b. Therefore, compressed air is also filled in the first air passage 21b. Since the main valve 41A is urged upward by the spring 41B, the main valve 41A is positioned at the upper end side of the groove 21a to shut off communication between the vent hole 41a and the compressed air accumulating chamber 22a in a state where the first air passage 21b is filled with the compressed air.

Upon operation of the operation valve 23 to allow the first air passage 21b to be communicated with the atmosphere, pressure at the lower end side of the main valve 41A becomes lower than the pressure at a portion other than the lower end side. Because of the pressure difference, the main valve 41A is moved downward against the biasing force of the spring 41B, so that the main valve vent hole (not shown) can be brought into communication with the compressed air accumulating chamber 22a. Accordingly, compressed air in the compressed air accumulating chamber 22a is flowed into the rotary sleeve 41.

The rotary sleeve 41 has an inner peripheral surface formed with a pair of recessed portions 41c extending in the vertical direction.

The rotary slide member 42 is disposed inside the rotary sleeve 41 and has protruding portions 42A engaged with the recessed portions 41c. The rotary slide member 42 is non-rotatable but vertically movable relative to the rotary sleeve 41. Each of the protruding portions 42A has a lower end portion defining an air shielding surface 42B in surface contact with a plate portion 52 (described later) so as to block fluid communication between upper and lower spaces relative to the rotary slide member 42.

The cylinder portion 5 defines therein a cylinder chamber 5a, and mainly includes a cylinder portion 51, the plate portion 52, and a piston bumper 53. The cylinder portion 51 is positioned within the housing 21 and is fixed thereto, and has a cylindrical shape and is positioned below the rotary sleeve 41. A return chamber 5b is defined outside the cylinder portion 51 and inside the housing 21. A compressed air outlet hole 51a is formed at a lower portion of the cylinder portion 51 to provide communication between inside of the cylinder portion 51 and the return chamber 5b. Further, an O-ring 54 which is a check valve is provided at an outlet opening of the compressed air outlet hole 51a so as to permit the compressed air to flow from the cylinder portion 51 into the return chamber 5b but prevents the compressed air from flowing from the return chamber 5b into the cylinder portion 51. Further, a compressed air inlet hole 51b is formed in the cylinder portion 51 at a position lower than the compressed air outlet hole 51a so as to allow the compressed air to flow from the return chamber 5b into the cylinder portion 51.

The plate portion 52 is positioned between the cylinder portion 51 and the rotary sleeve 41 and defines a cylinder chamber in cooperation with the cylinder portion 51 for accommodating therein the main piston portion 7. The plate portion 52 has a cylindrical portion formed with a communication hole 52a in communication with the third air passage (not shown). Thus, the compressed air flowing into the cylinder chamber is supplied to the pneumatic motor 31 through the communication hole 52a and the third air passage. The plate portion 52 has an upper flat surface in surface contact with the air shielding surface 42B. Thus, when the air shielding surface 42B is brought into surface contact with the plate portion 52 as a result of movement of the rotary slide member 42 toward the bottom dead center, the rotary slide member 42 is in intimate contact with the plate portion 52, which prevent the compressed air from flowing into the cylinder chamber 5a from a boundary between the rotary slide member 42 and the plate portion 52. Since the communication hole 52a is positioned below the flat surface of the plate portion 52, a supply of compressed air to the pneumatic motor 31 through the communication hole 52a is stopped as a result of intimate contact between the rotary slide member 42 and the plate portion 52, thereby stopping rotation of the pneumatic motor 31. A combination of the air shielding surface 42B, the plate portion 52 and the communication hole 52a functions as a motor braking mechanism.

The piston bumper 53 is made from an elastic material such as a rubber, and is positioned at a lower end portion of the cylinder portion 51 within the cylinder chamber 5a. As shown in FIG. 3, the piston bumper 53 is formed with a through-hole 53a extending in the vertical direction, and an O-ring 53A is provided in the through-hole 53a. A bumper base 55 is provided between the piston bumper 53 and the housing 21 so as to support the piston bumper 53 to the housing 21. The bumper base 55 is made from a high strength steel material and has an annular plate-like shape. Thus, the bumper base 55 supports the bumper base 55 when the impact force is imparted on the piston bumper 53 from above, and the impact force can be absorbed or buffered by the elastic deformation of the piston bumper 53.

As shown in FIG. 2, the auxiliary piston portion 6 includes a shaft 61, a driver bit assembling portion 62, an auxiliary piston 63, and a flange portion 64. These components are integrally formed.

The shaft 61 is located at an upper end portion of the auxiliary piston portion 6, and is assembled to the rotary slide member 42. The shaft 61 is constituted by an elongated sleeve extending in vertical direction. The shaft 61 has an upper end portion formed with an air supply hole 61a open to an interior of the rotary sleeve 41 at a position above the rotary slide member 42. The shaft 61 has a lower end portion formed with an air output hole 61b open to an upper hollow space 71a (described later) and communicated with the air supply hole 61a.

The driver bit assembling portion 62 is located at a lower end portion of the auxiliary piston portion 6. The bit section 1A can be assembled to the driver bit assembling portion 62. The driver bit assembling portion 62 has an outer diameter capable of engaging with the through-hole 53a (FIG. 3). The driver bit assembling portion 62 has a lowermost end portion defining an abutment portion 62A abuttable on a clutch plate 83 (described later).

The auxiliary piston 63 is provided at a lower portion of the shaft 61 and integrally therewith. The auxiliary piston 63 has an outer diameter greater than that of the shaft 61. An O-ring 63A is provided at an outer peripheral surface of the auxiliary piston 63.

The flange portion 64 is provided at a position between the auxiliary piston 63 and the driver bit assembling portion 62 and has an outer diameter smaller than that of the auxiliary piston 63 and greater than the diameter of the driver bit assembling portion 62. The flange portion 64 is adapted to be in abutment with the upper surface of the piston bumper 53 when the driver bit assembling portion 62 is inserted through the through-hole 53a of the piston bumper 53.

The main piston portion 7 mainly includes a main piston 71. The main piston 71 is of hollow cylindrical shape having an outer diameter smaller than an inner diameter of the cylinder chamber 5a. The auxiliary piston portion 6 is disposed in the space of the main piston portion 7, and the upper hollow space 71a and a lower hollow space 71b in communication therewith are arrayed in the vertical direction in the space of the main piston portion 7. The upper hollow space 71a has an inner diameter slightly greater than the outer diameter of the shaft 61, and smaller than the outer diameter of the auxiliary piston 63. An O-ring 72 is assembled in the upper hollow space 71a to provide a sealing performance between the shaft 61 and the main piston 71. The lower hollow space 71b has an inner diameter slightly greater than the outer diameter of the auxiliary piston 63. The O-ring 63A is in sliding contact with the inner peripheral surface of the main piston 71. Because the inner diameter of the lower hollow space 71b is greater than that of the upper hollow space 71a, a stepped portion 71A is provided at a boundary therebetween.

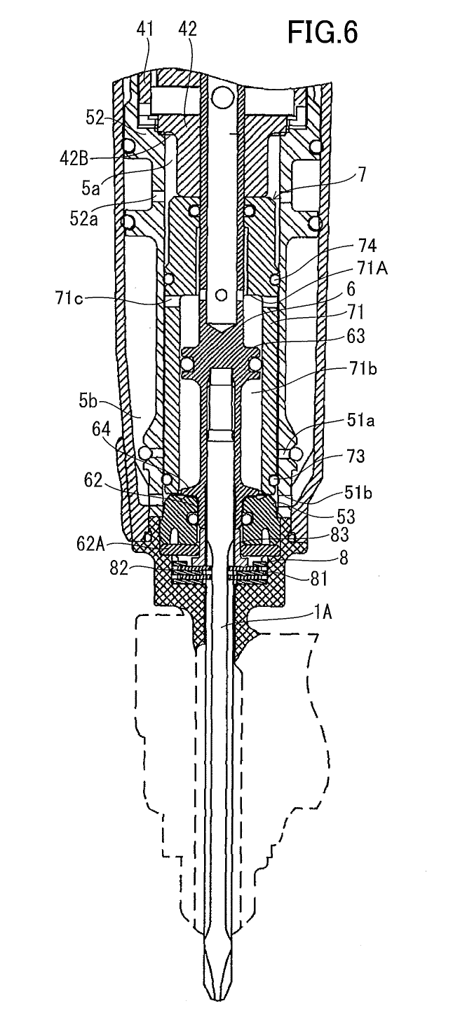

The main piston 71 is formed with a communication hole 71c open to the lower hollow space 71b and to the outer peripheral surface of the main piston 71 at a position near the stepped portion 71A. O-rings 73, 74 are provided on the outer peripheral surface of the main piston 71. As shown in FIG. 6, the O-ring 73 is positioned such that the O-ring 74 is positioned between the compressed air outlet hole 51a and the compressed air inlet hole 51b when the main piston 71 is moved to the bottom dead center position, i.e., when the main piston 71 is brought into abutment with the piston bumper 53. The O-ring 74 is positioned above the communication hole 71c.

As shown in FIG. 3, the clutch mechanism 8 is accommodated in the clutch accommodation space 21d, and includes outer clutch plates 81 as a first clutch plate associated with the housing 21, inner clutch plates 82 as a second clutch plate associated with the rotary assembly 4, and a clutch plate 83. As shown in FIG. 4, the outer clutch plate 81 is generally disc shaped having a center portion formed with a through-hole 81a through which the bit section 1A rotatably extends, and an outer peripheral portion provided with a plurality of protrusions 81A each engaged with each of the plurality of grooves 21f. Thus, the outer clutch plate 81 vertically movable relative to the housing 21, but is not rotatable about an axis of the outer clutch plate 81 in the clutch accommodation space 21d.

As shown in FIG. 5, the inner clutch plate 82 has a circular disc shape having a center portion formed with a through-hole 82a through which the bit section 1A extends. A plurality of projections 82A extend radially inwardly from an inner peripheral surface of the through-hole 82a, and each projection 82A is engaged with each groove 1a of the bit section 1A. Thus, the inner clutch plate 82 is vertically movable relative to the bit section 1A, but not rotatable relative to the bit section 1A in the clutch accommodation space 21d. That is, the inner clutch plate 82 is rotatable together with the rotation of the bit section 1A coaxially therewith.

In the clutch accommodation space 21d, two outer clutch plates 81 and two inner clutch plates 82 are provided. The outer and inner clutches are arrayed alternately so that the outer clutch plate 81 becomes the lowermost clutch plate. The clutch plate 83 has a hollow cylindrical portion through which the bit section 1A is insertable, and is positioned on an uppermost inner clutch plate 82. The clutch plate 83 has an upper portion inserted in the through-hole 53a of the piston bumper 53. As described above, the abutment portion 62A of the driver bit assembling portion 62 can be inserted into the through-hole 53a, the clutch plate 83 is urged downward by the abutment portion 62A. Because of the downward urging, the outer clutch plates 81 and the inner clutch plates 82 are pressed against each other to increase frictional force, which prevents the inner clutch plates 82 from rotating relative to the outer clutch plates 81. Since the bit section 1A is configured to rotate together with the inner clutch plates 82, the bit section 1A becomes non-rotatable because of the non-rotation of the inner clutch plate 82. That is, the bit section 1A is imparted with braking force.

As shown in FIG. 1, the nose portion 9 is positioned at the lower side of the main body 2. The nose portion 9 is formed with an injection passage 9a through which a screw supplied from the magazine 10 is positioned and configured to allow the bit section 1A to pass therethrough. The nose portion 9 is also formed with an injection hole 9b positioned at a lower portion of the nose portion 9 for allowing the screw to be injected outside. The nose portion 9 is provided with a push lever 91 and a screw feed portion 92. The push lever 91 is vertically movable at a position adjacent to the injection hole 9b and is movable in interlocking relation to the operation valve 23. The screw feed portion 92 is adapted to supply a screw from the magazine 10 to the injection passage 9a.

The magazine 10 is assembled to the nose portion 9 and accommodates therein a plurality of screws arrayed in a row by a connection band (not shown).

In operation, the fastening operation with the screw driver 1 is started by operating the operation valve 23 and the push lever 91 in the state shown in FIG. 1. In this case, operation can be started by pulling the trigger 24 to operate the operation valve 23 after the push lever 91 is pressed against a workpiece (not shown), or by pressing the push lever 91 against the workpiece while the trigger 24 is being pulled.

Upon connecting a compressor (not shown) to the compressed air inlet 22A, the compressed air is flowed into the compressed air accumulating chamber 22a and the operation valve 23. By operating the trigger 24 while the push lever 91 is being pressed against the workpiece, the main valve 41A is opened, so that the compressed air is flowed into the rotary sleeve 41 through an air passage (not shown), so that pneumatic pressure is applied to the upper surface of the main piston 71. Further, the pneumatic pressure is also applied to the upper surface of the auxiliary piston 63 by the compressed air passing through the air supply hole 61a, the air output hole 61b, and the communication hole 71c. Thus, the main piston 71 and the auxiliary piston 63 are urged downward. By the downward movement, the bit section 1A connected to the auxiliary piston portion 6 is brought into abutment with the screw positioned within the injection passage 9a. Thus, resistive force due to removal of the screw from the connection band is imparted on the auxiliary piston portion 6, so that the downward movement of the auxiliary piston portion 6 is decelerated. Accordingly, the main piston 71 catches up with the auxiliary piston 63 before a tip end of the screw is driven into the workpiece. Consequently, the main piston 71 and the auxiliary piston portion 6 are integrally moved downward for driving the screw into the workpiece with the bit section 1A.

Immediately before the main piston 71 reaches the bottom dead center, a supply of the compressed air which has been passing through the air supply hole 61a, the air output hole 61b, and the communication hole 71c into the return chamber 5b through the compressed air outlet hole 51a is started after the O-ring 73 is moved past the compressed air outlet hole 51a. On the other hand, the compressed air supplied into the rotary sleeve 41 is flowed into the cylinder chamber 5a and is supplied to the pneumatic motor 31 through the communication hole 52a to rotate the pneumatic motor 31. The rotation of the pneumatic motor 31 is transmitted to the rotary sleeve 41 and the rotary slide member 42 by way of the planetary gear mechanism 32. Therefore, as shown in FIG. 6, the bit section 1A is moved downward only by the thrust force of the auxiliary piston portion 6 after the main piston 71 reaches its bottom dead center to drive the screw into the workpiece.

In this case, air in the return chamber 5b cannot be flowed into the lower hollow space 71b positioned below the auxiliary piston 63 because of the contact between the bottom surface of the main piston 71 and the piston bumper 53. Therefore, compressed air in the return chamber 5b cannot be flowed into a portion below the auxiliary piston 63. Then, after the screw is fastened by a predetermined depth, the air shielding surface 42B is brought into abutment with the plate portion 52 to stop downward movement of the rotary slide member 42, and communication between the inside of the rotary sleeve 41 and the cylinder chamber 5a is shut off to stop supply of compressed air to the communication hole 52a. At approximately the same time, the flange portion 64 is brought into abutment with the piston bumper 53 to stop pneumatic motor 31, thereby completing the screw driving operation.

Concurrently with the abutment of the flange portion 64 onto the piston bumper 53, the abutment portion 62A of the driver bit assembling portion 62 is brought into abutment with the clutch plate 83 to increase frictional force between the outer clutch plate 81 and the inner clutch plate 82. Thus, rotation of the inner clutch plate 82 relative to the outer clutch plate 81 becomes impossible, thereby stopping rotation of the bit section 1A. With this structure, the clutch mechanism 8 can be utilized as a brake mechanism for stopping rotation of the rotary assembly 4.

In particular, the clutch mechanism 8 is activated while a moving portion including the auxiliary piston portion 6 and the main piston portion 7 reach the bottom dead center. Therefore, rotation of the bit section 1A after the auxiliary piston portion 6 and the main piston portion 7 reach the bottom dead center can be prevented to avoid excessive fastening of the screw. Incidentally, rotation of the pneumatic motor 31 is stopped concurrently with the reaching of the auxiliary piston portion 6 and the main piston portion 7 to the bottom dead center. Thus, excessive fastening of the screw can be effectively prevented in cooperation with the function of the clutch mechanism 8.

The clutch mechanism 8 directly stops the motion of the bit section 1A. Therefore, the bit section 1A which is a screw fastening member can be stopped by the clutch mechanism 8 even if a mechanism for stopping rotation of the pneumatic motor 31 is not operated. Thus, excessive fastening of the screw can be stably obviated.

Upon releasing the trigger 24, compressed air in the rotary sleeve 41 is discharged to the atmosphere, and compressed air in the return chamber 5b passes through the compressed air inlet hole 51b and is applied to a bottom end face of the main piston 71 whose diameter is slightly greater than that of the abutment surface of the piston bumper 53 to elevate the main piston 71. Thus, the main piston 71 can be returned to its initial position. At the same time, air shut-off function between the main piston 71 and the piston bumper 53 goes off due to the displacement of the main piston 71, so that compressed air in the return chamber 5b can be also applied to the lower portion of the auxiliary piston 63. Thus, the auxiliary piston portion 6 and the bit section 1A can be returned to their initial positions. Concurrently therewith, a subsequent screw (not shown) is fed to the injection passage 9a by the screw feed portion 92 for the next screw driving operation.

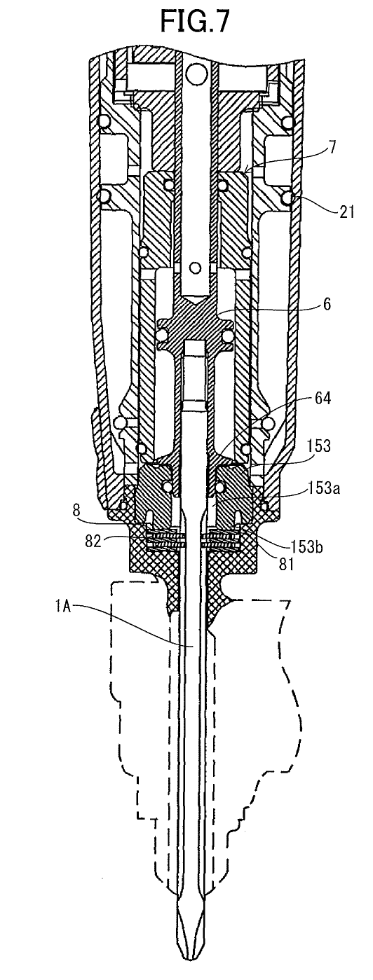

A modified embodiment is shown in FIG. 7. According to the above-described embodiment, a force of the auxiliary piston portion 6 is transmitted to the clutch mechanism 8 by the clutch plate 83 for braking function. On the other hand in the modified embodiment, impact force of the auxiliary piston portion 6 onto a piston bumper 153 can be used for braking function.

More specifically, the piston bumper 153 has a lower portion provided with an elongated abutment portion 153B extending downward and around a through-hole 153a. The abutment portion 153B is directly in abutment with the outer clutch plate 81 (in the modified embodiment, three outer clutch plates 81 and two inner clutch plates 82 are provided). With this structure, impact force by the impact of the flange portion 64 against the piston bumper 153 can generate pressing force between the outer clutch plate 81 and the inner clutch plate 82 for operating the clutch mechanism 8.

The above described embodiments pertain to the pneumatically-powered screw driver. However, electrically-powered screw driver or a combustion-powered type screw driver is also available in the present invention as long as the driver is provided with the bit and the rotary assembly that applies urging and rotation force to the bit.

While the invention has been described in detail with reference to the embodiments thereof, it would be apparent to those skilled in the art that various changes and modifications may be made therein without departing from the spirit of the invention.

What is claimed is:

1. A screw driver comprising:
a power source;
a rotary portion rotated by the power source and having a bit engageable with a screw, the rotary portion also having a moving portion holding the bit and movable between a top dead center and a bottom dead center in an axial direction of the rotary portion;
a housing rotatably supporting the rotary portion; and
a clutch mechanism provided between the rotary portion and the housing and coaxially with the rotary portion, and comprising a first clutch plate associated with the housing and unrotatable relative to the housing, and a second clutch plate associated with the rotary portion and movable in the axial direction and rotatable integrally with the rotation of the rotary portion, the first clutch plate and the second clutch plate being positioned to be urged by the moving portion and pressed together when the moving portion reaches the bottom dead center.

2. The screw driver as claimed in claim 1, wherein the second clutch plate is associated with the bit such that the second clutch plate is coaxially rotatable together with the rotation of the bit.

3. The screw driver as claimed in claim 1, wherein the power source comprises a motor that rotationally drives the rotary portion; and
the screw driver further comprising a motor braking mechanism configured to stop rotation of the motor in interlocking relation to a movement of the moving portion to the bottom dead center.
